(19) United States
(12) Patent Application Publication
(10) Pub. No.: US 2010/0077247 A1
(43) Pub. Date: Mar. 25, 2010

(54) COMPUTER AUDIO INTERFACE UNITS AND SYSTEMS

(76) Inventors: Andrew Charles McHarg, Ely (GB); Christopher Roy Hales, Cambridge (GB)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/563,804

(22) Filed: Sep. 21, 2009

(30) Foreign Application Priority Data
Sep. 19, 2008 (GB) 0817141.5

(51) Int. Cl. G06F 13/42; G06F 1/00; G06F 17/00

(52) U.S. Cl. 713/400; 713/500; 700/94

(57) ABSTRACT

A computer audio interface unit (110) comprises a serial computer interface (e.g. USB) (204) providing a connector (112) for connection to an external, computer-based source (100) of digital audio data samples. A digital audio output connector (130) provides a digital audio output signal to external audio reproduction apparatus (106, 108). A word clock output connector (134) provides a word clock signal to external audio reproduction apparatus, in parallel with said digital audio output signal. An encoder (202/308) receives digital audio data via said USB interface and outputs said digital audio output signal. Clocking circuitry (202/300, 312) is responsive to a timing reference signal (200) independent of said external source (100), and generates said word clock signal for output to the external reproduction apparatus. Said clocking circuitry further generates a clock signal (302) for the USB interface (204) so as to synchronise the drawing of said audio data samples via said USB interface with the generated external word clock signal and the digital audio output signal. Interface and encoder functions may be housed separately from a master clock function.

### RELATED APPLICATION

This application claims the benefit of Great Britain patent application no. GB 0817141.5 filed Sep. 19, 2008, the entire disclosure of which is herein incorporated by reference.

### FIELD OF THE INVENTION

The invention relates to computer audio interface units, particularly for high fidelity reproduction of music and like material stored in computer-based devices such as PCs and networked media servers.

### BACKGROUND

In the high fidelity separates market, various measures and upgrade options are provided for the consumer to improve their listening experience when playing music recorded digitally, for example on CD or, more recently SACD formats. A high-end set-up will commonly separate the functions of disc transport and digital to analogue conversion (DAC) into separate units. A high quality timing reference may be added using word clock lines parallel with the digital audio data interface. The present applicant for example supplies Scarlatti™ components including a separate master clock unit incorporating a temperature compensated crystal oscillator for extreme accuracy.

There is an increasing trend for consumers to store music in computer-based systems such as PC hard drives, networked media streaming servers etc. Much of this music is stored in compressed form to compromise storage requirements with audio quality. Lossless formats are also used, however, to retain quality equivalent to or optionally higher than CD and SACD® sources.

Unfortunately, however, existing solutions do not allow the input of computer-based digital audio streams into high-end audio systems with the flexibility required to benefit from high accuracy clocking and other improvements.

The most common serial computer interface used for audio data nowadays is USB. In the marketplace today there are USB DAC products, which allow an analogue amplifier input to be fed from the computer. There are alternatively USB-SPDIF converters which convert from USB to SPDIF audio format. With regard to timing, most USB audio interfaces requires the audio device to lock to the USB frame synch, which is generated in the computer and has specification not ideal for audio use, e.g. a tolerance of ±1000 ppm in absolute frequency terms. As well as absolute frequency (i.e. pitch) errors, the audio device in that case can never be adequately immune from the PC as a source of jitter, which will be several magnitudes worse than a local oscillator.

The USB standard does provide for an asynchronous isochronous mode of transfer, but this is not widely adopted.

The inventors have therefore identified the following problems with existing USB DAC products:
Having USB natively inside DAC means another clock inside DAC not correlated with audio clocks, causing possible clock contamination.
USB also capable of carrying EMI from PC inside DAC, causing noise in delicate analogue electronics.
A standalone DAC has no capability of slaving to another clock source, which the consumer might own and prefer.
A standalone USB DAC does not exploit the investment and quality of a standalone DAC unit which the consumer might already own.

Problems identified with existing USB to SPDIF converters are:
None use asynchronous mode
None provide word clock outputs for lower jitter slaving of DAC, making the converters vulnerable to data-induced jitter.
None use a high-grade oscillator such as a OCXO or provide an input for a word clock input, so even if they were to use asynchronous mode, jitter and absolute frequency would be worse.

### SUMMARY OF THE INVENTION

The inventors have sought a better solution which allows users to play sound files from a PC using the USB to SP-DIF conversion mechanism, without sacrificing the quality of high-end DAC and amplifier stages, loudspeakers etc., and in as cost-effective and flexible a way as possible, to take advantage of existing high quality components.

The invention in a first aspect provides a computer audio interface unit comprising:
a serial computer interface providing a connector for connection to an external, computer-based source of digital audio data samples;
a digital audio output connector for providing a digital audio output signal to external audio reproduction apparatus;
a word clock output connector for provision of a word clock signal, in parallel with said digital audio output signal, to external audio reproduction apparatus;
an encoder for receiving digital audio data received via said serial computer interface and outputting said signals via said digital audio output connector; and
clocking circuitry responsive to a timing reference signal independent of said external source, for generating said word clock signal for output to the external audio reproduction apparatus and for generating a clock signal for the serial computer interface, so as to synchronise the drawing of said audio data samples via said serial computer interface with the generated external word clock signal and the digital audio output signal.

It is to be understood that ‘internal’ and ‘external’ refer to the unit as an item of consumer or professional audio equipment made and soled separately from other units. The ‘unit’ in this context may typically be regarded as a collection of components assembled within a stand-alone housing with its own power supply, the housing and power supply being designed to providing electromagnetic, mechanical and acoustic isolation to an arbitrary standard. Optionally, the ‘unit’ could be an add-on module adapted to fit within a housing which already contains other circuits.

In one embodiment, the serial computer interface is a USB interface operable in asynchronous isochronous mode. More than one USB connector may be provided.

The serial computer interface may be implemented in an integrated circuit separate from the other components mentioned. In such a case, the clocking circuitry may be arranged to generate two clock signals for application to the computer interface integrated circuit, namely an audio master clock signal at a frequency related to the sample rate of said digital audio data (e.g. 44.1 kHz or 48 kHz) for clocking audio data out of the serial computer interface integrated circuit and a computer interface clock signal at a different frequency (e.g. 6 MHz or multiple for USB).

The interface unit may include more than one word clock output for provision of word clock signals to more than one external unit.

The interface unit in a first preferred embodiment may be provided with a number of word clock output connectors greater than the number of digital audio output connectors. This allows the unit to provide word clock to external destination and source devices synchronously, with the transmission of a digital audio signal directly between the external devices.

The interface unit may include an internal timing reference source for providing said timing reference signal.

The timing reference may have an operating accuracy better than 10 parts per million (ppm), and preferably better than 1 ppm when stabilised. The timing reference may include for example a oven-controlled crystal oscillator (OCXO). In a preferred embodiment, the OCXO is based on a 14.112 MHz crystal, the frequency being multiplied and divided to give 44,100 Hz and/or 48,000 Hz word clocks as desired.

The interface unit may comprise an external word clock input for receiving said timing reference signal from an external timing reference source.

The interface unit in a second preferred embodiment has just one word clock input connector and one word clock output and connector, on the assumption that the external timing reference source can supply word clock signals to multiple units if required.

The interface unit may be provided in combination with a separate timing reference unit connectable to provide said timing reference signal. The external timing reference unit may provide a plurality of word clock output connectors while the interface unit provides only one word clock output connector.

The interface unit may contain both an internal timing reference unit and an input for an external timing reference.

The interface unit may be provided in combination with an external timing reference unit having an accuracy greater than that of the internal timing reference unit.

The interface unit (with optional external timing reference unit) may be provided in combination with an external disc transport unit, the disc transport unit having a word clock input and a digital audio output, and a disc reading mechanism operable synchronously with signals received from the interface unit via the word clock input.

The interface unit may be provided in combination with a digital-to-analogue conversion unit (DAC) which has a word clock input and a digital audio data input suitable for receiving digital audio signal and word clock signals output by the interface unit. The DAC unit may have inputs for digital audio signals from sources other than the interface unit. The DAC unit may be operable to reproduce audio from said other sources using the word clock

The clocking circuitry and encoder may be operable to output digital audio at different sample rates selectable in accordance with a nominal sample rate of said external source. The interface unit may include a frequency selector for controlling the clocking circuitry automatically in response to control information received from the computer-based source through the serial computer interface to generate said word clock with a frequency compatible with data received from the computer-based source. The frequency selector may be arranged automatically to revert to a user selected frequency in the absence of audio data from the serial computer interface.

The clocking circuitry may be operable to generate said word clock at one rate for all sample rates based on 44.1 kHz and at another rate all sample rates based on 48 kHz. In a preferred embodiment, the word clock is either 44.1 kHz or 48 kHz, depending on the audio sample rate.

The digital audio output interface may be in SPDIF/AES format, via SPDIF and/or AES standard output connectors.

The digital audio output interface may be in DSD® format via an IEEE 1394 standard or other connector.

The encoder may include a rate conversion function operable to increase the sample rate of the output digital audio data relative to the rate of the data received from said external audio data source.

The rate conversion function may be further operable to increase the number of bits per sample relative to the rate of the data received from said external audio data source.

Other signal processing and transforming functions can of course be implemented.

The invention further provides a system of digital audio units comprising one or more of the combinations of units mentioned above, with appropriate interconnections in place.

### BRIEF DESCRIPTION OF THE DRAWINGS

FIG. 1 is a schematic diagram of an audio entertainment system incorporating a master clock and interface unit according to the present invention;

FIG. 2 is a hardware block diagram of the master clock and interface unit according to one embodiment of the invention;

FIG. 3 is a functional block diagram of the same master clock and interface unit;

FIG. 4 is a more detailed functional diagram of a clock generator in the unit of FIGS. 2 and 3; and

FIG. 5 is a functional block diagram of the second embodiment of the invention, in which interface/conversion functions are housed separately from a master clock function.

### DETAILED DESCRIPTION OF EXEMPLARY EMBODIMENTS

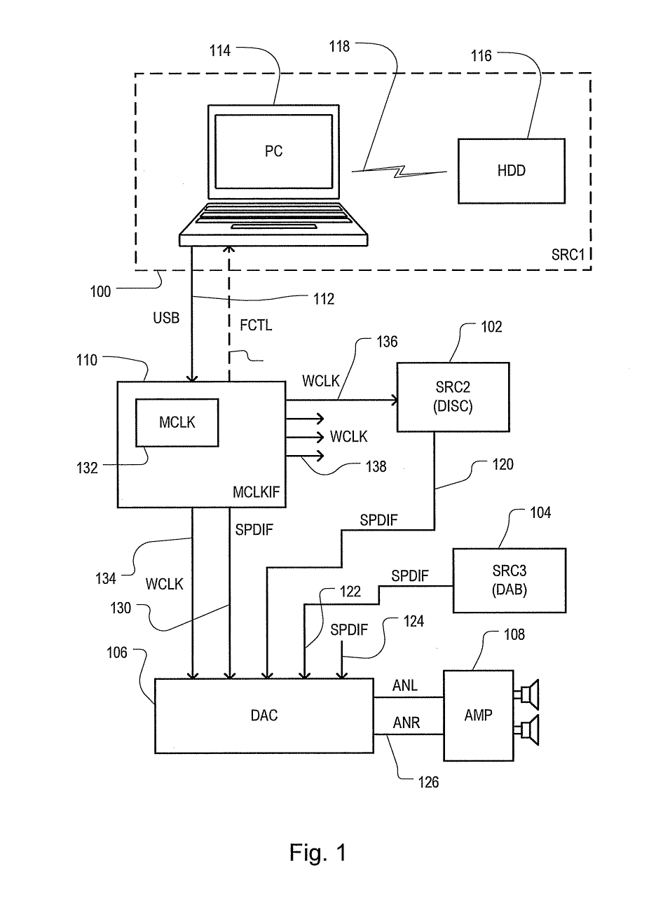

FIG. 1 shows a block schematic from a high-fidelity consumer audio installation comprising a number of digital audio sources 100, 102, 104 driving a separate digital to analogue converter (DAC) 106 and analogue audio amplifier 108. While systems having these components are known, the novel system further includes a separate master clock and interface unit 110, which has novel functionality and directly increases the quality and versatility of the system. A high-quality DAC product is the applicant's Ring DAC technology described for example in U.S. Pat. No. 5,138,317. This is a discrete balanced design, does not use any off-the-shelf DAC chips commonly found in other manufacturers' product.

Describing the components in more detail, the first source 100 is a computer-based system connected to the other components via a USB interface 112. A typical set-up comprises a laptop PC or dedicated media streaming unit, coupled to a media server storage device 116 via a wireless network 118. As the server 116 may be in a different room from the audio components, noise from disc drives, cooling etc will not detract from the listening experience.

Source 102 is a stand-alone disc transport, adapted for example to play CD and SACD® discs. Digital audio signals are output to the DAC 106 via an SPDIF or equivalent interface cable 120. The third source 104 is also connected via an SPDIF cable to an additional input of DAC 106, and may be, for example, a DAB® or similar digital radio receiver. Additional digital audio inputs 124 may be provided by DAC 106. Depending which source is selected, digital data from the source is converted to analogue signals, coupled via cables 126 to the output amplified 108.

SPDIF is a common digital audio format which firstly conveys frames of digital audio data samples either of a single channel or of left/right channels interleaved, but also is encoded so as to allow the clock signal to be recovered from the waveform by a PLL. DACs, whether stand-alone units or integrated into amplifying equipment, are generally adapted to recover a clock signal from the SPDIF waveform, so that a separate timing connection is not required. On the other hand, the recovery of timing information from a data-containing waveform inevitably introduces a degree of jitter, and potentially distortion in the output audio signal. Furthermore, of course, the quality of timing in the SPDIF signal when it is generated depends on the quality of timing references, noise sources etc present in the source apparatus. The disc transport 102 contains motors and other noise sources.

The master clock and interface unit 110 has a dual function in this set up. Firstly, it takes care of the USB interface connection 112 to the first source 100, converting data received from the computer into a further SPDIF stream connected at 130 to a further input of DAC 106. Secondly, unit 110 contains a high stability master clock module 132, which provides a high-quality timing reference for any digital audio source and destination that can accommodate such a signal. Unit 110 is provided with a number of word clock output connectors 134, 136, 138 etc. These provide a timing reference for the accurate reproduction of audio samples, separately from timing information that may be conveyed along with the sample data, for example, through SPDIF connections. Word clock 134 runs in parallel with SPDIF connection 130 to the DAC 106, which is operable to control its conversion and outputting of audio information to amplifier 108 in accordance with the received word clock, rather than timing information from an SPDIF source. Similarly, word clock output 136 is connected to disc transport 102, so that the spinning and pick up of information from the disc can be synchronised with master clock module 132 and DAC 106 without relying solely on SPDIF to carry the clock information.

Spare word clock outputs 138 are available so that a number of sources additional to disc transport 102 can be driven as desired.

Third source 104 does not have the word clock input facility. This may be because of the nature of the source (a broadcast whose timing is dictated by the broadcaster), or simply the source equipment is not provided with an external word clock input and relies upon its own internal clock. This may be a digital audio tape or mini-disc player, a DVD player, games console etc. Either way, DAC 106 will need to synchronise with that source.

Most importantly, the USB interface 112 is controlled to operate in the “asynchronous isochronous” mode, such that the timing of transfer of audio data samples from PC 114 to unit 110 is controlled by master clock reference 132. In this mode, a flow control channel 140 is established and clock signals transmitted from unit 110 to the PC USB interface, so that audio data from the PC can be synchronised with the word clock output 134. In this way, PC-originating samples output on SPDIF connection 130 can be reproduced by the DAC/amplifier 106/108 under the control of master clock reference 132, without sample rate conversion but independently of the clock generators internal to the PC, or the clock of the USB interface. Thus the same high quality of timing can be obtained, whether the user is listening to music from the disc transport 102 or from the computer server 116. Transport 102 and DAC 106 can be combined in an integrated disc player product if desired. (The applicant's Puccini™ player is such a unit.)

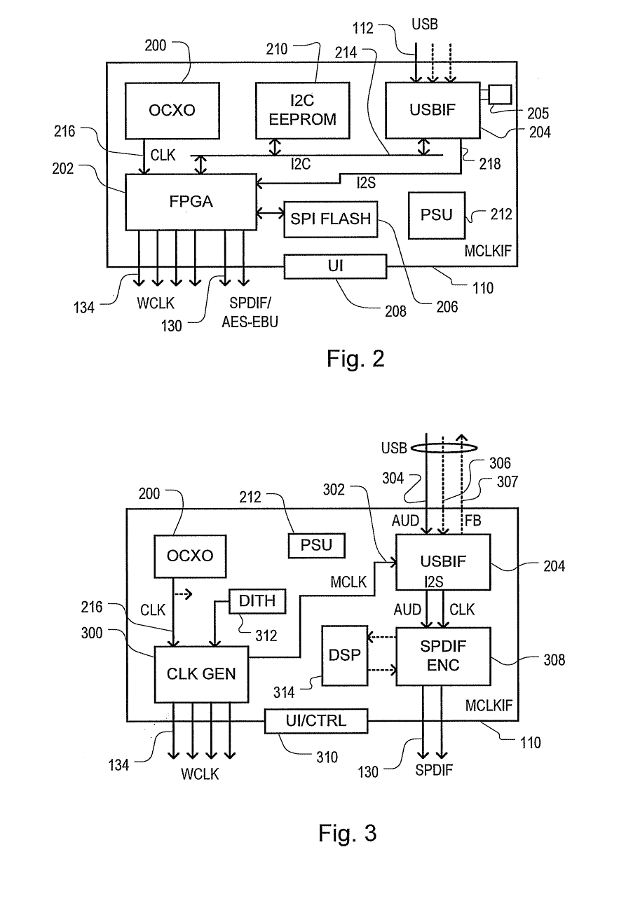

FIG. 2 shows the internal architecture, in hardware terms, of the master clock and interface unit 110 in a first embodiment of the invention. The same reference signs will be used for components seen already in FIG. 1, it being understood that FIG. 2 does not show the only possible implementation of the desired functionality. The three key elements are a temperature controlled crystal oscillator 200, a field programmable gate array (FPGA) 202 and USB-audio interface 204. USB interface 204 has its own crystal 205, by which it can generates a 6 MHz and 12 MHz clock for its own purposes. Additional components are flash memory 206, user interface controls (front panel) 208, electrically erasable programmable memory (EEPROM) 210 and a power supply unit 212. These components are housed in a casing separate from other units, providing both mechanical and electrical isolation from, say, the disc transport and DAC components. An I²C bus connection 214 connects FPGA 202, memory 210 and USB interface 204.

USB interface 204 can be implemented readily by suitable programming of a USB streaming controller chip such as Texas Instruments' type TAS1020B. I²C interface 214 allows for control of interface 204 by the FPGA 202, while interface 204 provides one or more USB input/output ports 112 and a digital audio outlet port in I²S format 217. The TAS1020B chip includes a programmable type 8052 microprocessor core, which is programmed to implement functions required for the present application. More detail of this programming will be described below, including how the inventors have overcome the TAS1020B's lack of support for the feedback pipe in asynchronous isochronous mode.

Oscillator 200 provides an extremely accurate master clock reference signal through connection 216 to FPGA 202. FPGA 202 also is connected to work clock outputs 134 etc and digital audio (SPDIF) outputs 130 etc.

FIG. 3 shows the same master clock and interface unit 110, but this time revealing the functional architecture, rather than hardware architecture. The oven controlled crystal oscillator 200 and USB interface 204, as well as power supply unit 212, naturally appear as functional units in their own right. By virtue of the programming of FPGA 202, the following additional functional blocks are then implemented. A clock generator 300 receives the clock reference signal from oscillator 200, and generates word clock signals seen at the outputs 134 etc. A master clock signal is also generated and supplied via line 302 to a master clock input of the USB interface 204, for controlling the output of data received from the USB host in asynchronous isochronous operation. A USB clock at a different frequency is supplied for the USB operation itself, as mentioned already, and the host has its own, asynchronous clock. Through the USB interface 112 and its standard protocols, an audio data ‘pipe’ 304 is established in accordance with parameters received from the computer source (100 in FIG. 1) through a control pipe 306. A feedback pipe 307 is also established, to control the rate of feeding audio data into pipe 304, when the host and master clock are asynchronous.

Audio and clock signals synchronised with the master clock are generated in an SPDIF encoder function 308. This drives the SPDIF outputs 130. A user interface and general control function 310 is implemented by FPGA 202 in conjunction with front panel components 208. Also provided is a dither signal generator function 312, which injects a small random variation into the word clock generator 300, which can be used to “exercise” the PLL circuits of external units. An optional DSP (digital signal processor) function 314 is provided to process digital audio received from interface 204, prior to output. Such processing may comprise simple sample rate conversion, or more complex functions such as “room correction” equalisation and the like.

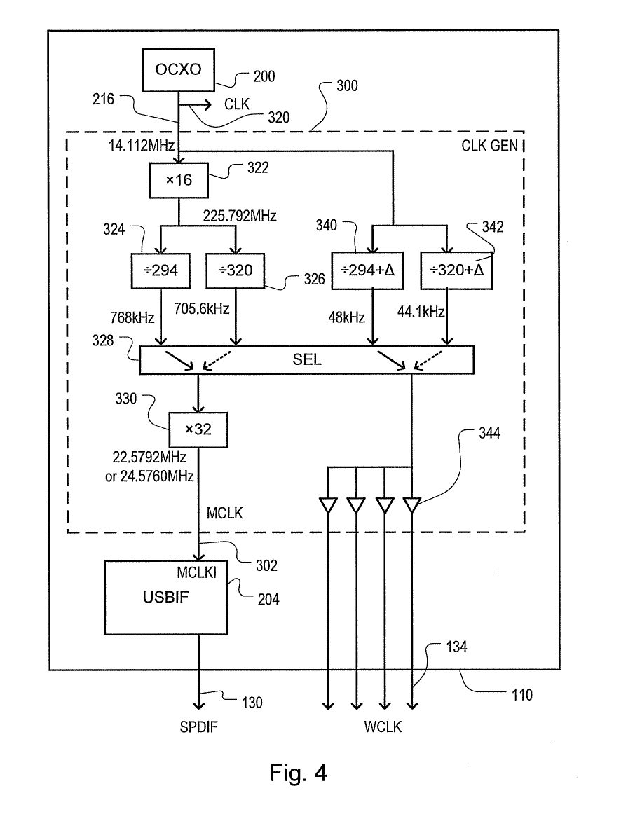

FIG. 4 shows in more detail the functions within clock generator 300 in the interface unit 110 of FIGS. 2 and 3. The 14,112 MHz reference clock is received from OCXO 200 on line 216. Line 320 carries the same clock signal throughout the FPGA for use in sequential operations. Frequency multiplier 322 multiplies the frequency by sixteen to 225.792 MHz, which is then fed to two frequency dividers, 324, 326. Divider 324 divides by 294 to give an output at 768 kHz, while divider 326 divides by 320 to yield 705.6 kHz. A selector (multiplexer) 328 feeds a selected one of these to a further frequency multiplier 330, which outputs either 22.5792 MHz or 24.576 MHz, according to the state of the selector. This is the master clock supplied on line 302 to the master clock input of the USB interface.

Another copy of the 14.112 MHz reference clock is fed to two further frequency dividers, 340, 342. Divider 340 divides by 294 to give an output at 48 kHz, while divider 342 divides by 320 to yield 44.1 kHz. Selector (multiplexer) 328 feeds a selected one of these to a set of buffers 344 which drive the word clock outputs 134 of the unit 110. The division factors, nominally 294 and 320, are indicated as ‘294+Δ’ and ‘320+Δ’ to indicate that the dither function (312 in FIG. 3) can be implemented by introducing a carefully controlled random variation in these division factors. The dither is designed to introduce noise only in bands which will be filtered out.

### Principles of Operation

The approach of using an oven controlled crystal oscillator (OCXO) together with asynchronous isochronous transfer mode ensures that the absolute frequency generated is as accurate as desired, regardless of the PC used, and that any jitter generated by the PC has no way of propagating into the audio chain. In addition, the provision of a number of word clock outputs driven by the same oscillator allows easier reduction of jitter by audio devices downstream, compared with native SPDIF, together with the ability to have a large number of devices synchronised in the system. These word clocks are configured such that they output a frequency natively compatible with the USB audio rate.

The unit 110 is designed to generate and accept industry standard Word Clock on 75 ohm co-axial cable. Clocks can drive other manufacturers' equipment designed to accept standard Word Clock. Non-standard clock formats may be supported if desired.

In USB, there are numerous modes for synchronising the audio between the PC (the host), and an audio device. The most popular of these, “adaptive”, involves the audio device synchronising itself to the USB “frame” provided by the PC. This tends to give poor jitter performance.

The unit 110 operates in the less common “asynchronous isochronous” mode (not to be confused with asynchronous rate conversion), where the audio device synchronises the audio by providing a feedback pipe to the PC. The PC then is effectively locked to the audio device, which can have a much more accurate clock and much lower jitter.

The host (PC) 100 and client unit 110 both know how much bandwidth is available at the outset, so the host can guarantee that bandwidth will be available all the time. Music may be stored on a large Hard Disc Drive (HDD) in a different room, linked by Wi-Fi® to a small, silent device (such as a laptop) connected by USB cable to the interface unit 110. When the user selects the audio for playback, the computer host streams all of the selected data from the HDD or Network Assigned Storage (NAS) device, then outputs the data on USB.

The audio flowing between the PC and unit 110 is packetised PCM at 32, 44.1, 48, 88.2 or 96 kS/s. It is the job of the codecs installed on the PC to decode the data and present it to unit 110 in a standard PCM format. USB frames are transmitted at a fixed rate, unrelated to the audio sample rate. Within each frame, a number of bytes can be sent as a data packet carrying audio data. The size of the payload per packet, rather than the frequency of the packets, is adjusted under control of the feedback pipe to match the (average) rate of data supplied with the demand dictated by the master clock. This control process will now be explained in a little more detail.

USB data transport is performed in frames which are sent nominally every 1 ms (1 kHz frame rate, measured by the host's USB clock). The host PC interface operates with a nominal 12 MHz clock, but this is only approximately 12 MHz, and certainly of no accurately fixed relation to the codec master clock MCLK. Therefore, the ideal 1 kHz rate is only approximately achieved. Consequently, when a pipe 304 of, for example, 44100 samples per second (S/s) is established from the host to the interface 204, and a word clock of 44100 kHz is selected in the clock generator 300, the difference in the actual values means that inevitably, over time, supply will exceed demand or vice versa, and buffer overflow or underflow will result in lost data. The asynchronous isochronous mode is implemented to avoid this situation, using the feedback pipe 307 regularly to update the requested sample rate.

In the preferred embodiment, this feedback pipe caries a 3-byte value every 2 ms (the highest permitted rate for feedback in USB protocols). For a nominal 44100 S/s the feedback value may begin as ‘44100’. The host then calculates how many audio samples should be sent in each USB frame, on average, to match its supply to the demanded ‘44100’. The host then ensures that the calculated number of samples, on average, are inserted into the pipe in each frame. (Also specified is the maximum number of audio samples carried in any USB frame, to allow proper buffer design and management.) These samples are received in interface 204 are saved in a RAM buffer (FIFO), to be read out by the SPDIF or similar codec.

Given the inevitable mismatch between 44100 S/s as measured by the host's clock and 44.1 kHz measured by the interface master clock & word clock, interface 204 is programmed by the inventors to monitor the buffer state and vary the feedback value continuously so as to avoid underflow and overflow. The feedback value may thus read 44100 for a while, then 44110, 44108, 44091, etc., constantly adjusting to maintain the isochronous operation of the PC-based data source and the OXCO-based playback system.

When powered up, the unit 110 performs the following routine:
FPGA configures itself via “Master Serial” from SPI Flash
FPGA connected to I²C of TAS1020B.
FPGA contains application code in Block RAM, so when TAS boots, it can bootstrap itself from FPGA via I²C. User settings are saved and restored from EEPROM 210.
FPGA generates & selects EITHER a 22.5792 or 24.576 MHz master clock MCLK, according to base frequency required.
FPGA uses this to clock SPDIF encoders, and MCLKI (codec master clock) of TAS1020B.
Decodes the audio provided in I²S by the TAS1020B, to feed to SPDIF encoder at an appropriate rate.
Generates word clock output including desired random dither.

Particularly when made to very high fidelity specification and significant cost, the product should be beneficial to the system even when USB is not being used.

In addition to configuring the logic gates, memory and so forth within FPGA, programming code has to be written also into the program memory of the 8052 processor core in the TAS1020B (assuming that chip is used as the USB interface 204. The interface chip in operation requires to implement three main functions: a USB engine, a codec engine and a DMA engine.

The programmed code includes functions such as:
Measuring buffer usage every USB ‘tick’ (every 1 ms).
Calculating and returning a feedback value via feedback pipe 307 (see below).
Communicate with FPGA user interface and control function 310 for muting, change of sample rate and so forth.
General set-up and housekeeping such as setting the codec mode to I²S, defining the codec clock mode, interfacing with other hardware.

These functions are within the capability of the skilled person equipped with a datasheet and development tools for the chose interface chip. A particular difficulty with the TAS1020B chip, although it can be set to operate in the desired asynchronous mode, is that it does not provide support for the feedback pipe required to put that mode into practice. The inventors have devised a solution to force the desired behaviour, which will be briefly described for completeness.

Messages via the USB control pipe 306 are used to set up the asynchronous isochronous audio data pipe with a capacity to suit the data (for example, 192 bytes per 1 ms USB frame will carry 16-bit stereo PCM audio at 48 kS/s), this being directed though a FIFO buffering process to a first I²S port of the TAS1020B interface. The smallest bandwidth permitted by the USB standard or the chip is 8 bytes per 1 ms frame. The appropriate feedback pipe from the USB perspective comprises 3 bytes per alternate frame (per 2 ms).

Since the TAS1020B does not directly implement such a channel, the inventors have designated a second channel, flowing from the interface 204 to the host, which the interface chip will regard simply as more audio data. The difficulty then arises, in that DMA engine in the TAS1020B chip is designed not to trigger a transfer from codec to USB until at least 8 bytes are waiting to be sent. The inventors' solution to this is to program the 8052 core to manipulate the DMA pointers so as to simulate the availability of 8 bytes of data, so that these will be transferred to the USB output buffer and on to host via feedback pipe 307.

The DMA pointers are reset every frame, so the same 3 bytes are all that gets sent. As a precaution, however, the next three bytes in the appropriate buffer are written with a repeat of the feedback value to be transmitted. That way, if the controller should ever fail to reset the buffers, the same 3-byte value will simply be transmitted again in the next feedback frame.

The invention is by no means limited to use of the TAS1020B chip, however, and different chips will require more or less coding effort in different areas, to implement all the functions required.

### First Commercial Example

A first commercial embodiment of unit 110 features a grade 1 system clock, driving four word clock outputs. Owners of the applicant's Puccini™ disc player can for example play sound files from a PC via the dCS Ring DAC on board the Puccini™. Asynchronous isochronous USB mode prevents the source injecting jitter into the DAC unit. High grade aluminium chassis and laminated acoustic damping panels to reduce magnetic effects and vibration.

Starting with an oven controlled crystal frequency of 14.112 MHz, word clock frequencies of 44.1 kHz or 48 kHz can be generated which are accurate to better than ±1 ppm when shipped over an ambient temperature range of 10° C. to 30° C. Temperature control of the crystal is provided by a special oven, in a manner known per se. Accuracy typically ±0.1 ppm accuracy is achieved in the commercial example, when a unit is shipped and stabilised. Use of a single crystal frequency allows cost of such an arrangement to be reduced, compared with the common practice of using separate crystals at 22,972 MHz and 24,576 MHz to generate these standard audio frequencies.

Four independently buffered word clock outputs 134, all carry the same clock frequency on 75 ohm BNC connectors. USB 1.1 or 2.0 interface 304 on type B connector accepts uncompressed audio data at 32, 44.1, 48, 88.2 and 96 kS/s. With the USB interface active at 32, 48 or 96 kS/s, the word clock outputs are set to 48 kHz. With the USB interface active at 44.1 or 88.2 kS/s, the word clock outputs are set to 44.1 kHz. The USB audio protocols specify sample size and rate when setting up the audio stream, so that the UI/control function 310 within interface unit 110 is able to adjust the frequencies appropriately. The clock circuitry may generate master clock signals MCLK at much higher frequencies for internal use, synchronised with the word clocks.

Unit 110 in this embodiment will present data received via the USB interface, unprocessed, in SPDIF format on 2× RCA phono connectors. Compatible with Windows XP, Windows Vista and Mac OS X 10.5, it uses the “Audio Class” in USB. This means no special drivers are required, and any playback software can access unit 110 as an audio device (trade marks of Microsoft Inc. and Apple Corp. acknowledged).

When Playing CD/SACD® in the first embodiment:
Word clock frequency is user-selected to suit a current source.
System benefits from improved clock.
DAC Benefits from being able to lock to word clock rather than a self-clocking input like SPDIF. (DAC reverts automatically to deriving clock from SPDIF if word clock frequency is wrongly set.
Impossible for Transport motor to affect the clock to the DAC.
SPDIF outputs from unit 110 are turned off, so no possibility of injecting noise via crosstalk.

When Using USB
Because of asynchronous mode, PC audio is effectively being clocked by hi-precision oscillator within unit 110, so cannot affect timing or jitter.
Word clock automatically switches to suitable frequency upon detecting audio received from USB.
Word clock allows DAC to lock with lower jitter.
Still using OCXO 200, so performance comparable with CD/SACD® playback.
Having USB in a separate box means no chance of cross-clock contamination within the DAC, or noise from PC injecting itself via USB

### Second Commercial Example

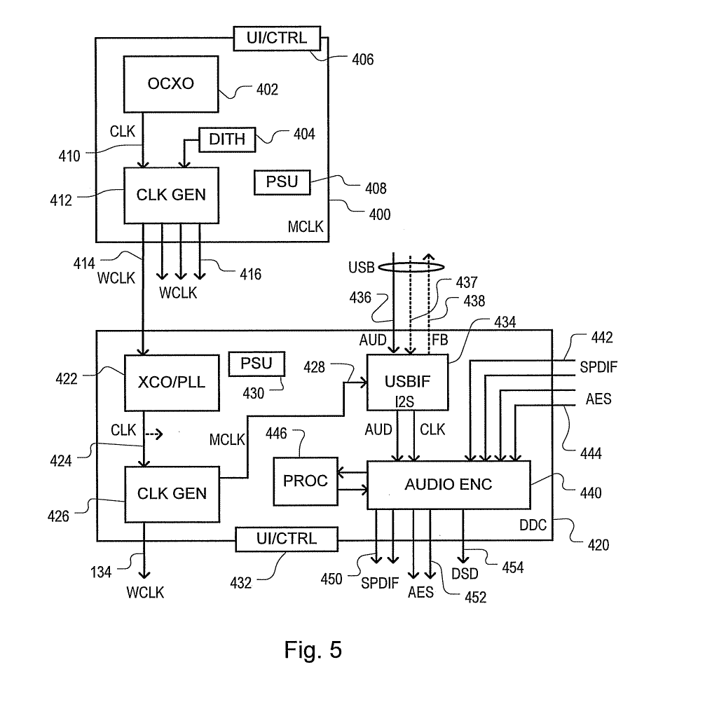

FIG. 5 shows an alternative embodiment in which the master clock reference and USB interface functions are provided in separate units, and the interface function is combined with a more general digital data converter (processing) function.

Master clock reference unit 400 houses a temperature controlled crystal oscillator 402 and dither generator 404 of the type described already in relation to the first embodiment. Being in a separate casing, its own user interface and control function 406 is provided, as well as power supply 408. A reference block signal is passed at 410 to a word clock generator 412, which drives a set of individual word clock outputs 414, 416 etc.

Unit 400 may be a pre-existing product such as the Scarlatti™ master clock reference supplied by the applicant dCS, for use with its pre-existing transport and DAC units (not shown).

The novel part of the architecture then is added with the provision of the digital data converter unit (DDC) 420. This has a timing unit 422 which can receive word clock signal from output 414 of the master clock reference 400, and pass the clock at 424 to a clock generator 426, which is the same as function 300 in the first embodiment. Master clock signals 428 etc are generated by multiplying up the word clock, and supplied to other functions within DDC 420. USB clock (not shown) is generated at 6 or 12 MHz, for use by the USB interface 434, described below.

The clock unit 422 may have its own crystal oscillator (XCO) function so that DDC 420 can be used without master reference clock 400. Alternatively, the high quality temperature compensated (oven controlled) or similar crystal oscillator 402 may be integrated directly in DDC 420 (this results in substantially the architecture of FIG. 3).

DDC 420 has its own power supply 430 and user interface/control function 432. USB interface 434 is provided, similar or identical to the interface 204 in the FIG. 2-3 embodiment. A USB input (there could be more than one) receives an audio data stream 436 and provides a timing reference (clock) and flow control 438 to the USB source. An audio encoder and switching unit 440 receives audio and clock information via I²S interface from the USB interface 434. In this example, however, encoder unit 440 can also receive audio signals from other sources via SPDIF® inputs 442 and AES inputs 444. Depending whether those other sources have word clock inputs, the timing of those inputs 442, 444 may be synchronised with word clock signals output by master timing reference 400. A processor function 446 is implemented within DDC 420, in particular to provide various sample rate and sample resolution conversion functions, particularly up-sampling functions.

Converted audio is output by unit 440 to outputs 450 (SPDIF), 452 (AES) and/or 454 (DSD®). Those skilled in the art will understand that SPDIF and AES are different physical layer formats for a common serial data-bit stream. DSD®, on the other hand, is a one-bit format, carried through IEEE 1394 physical layer.

In one application, digital-to-digital converter (DDC) 420 converts digital audio data at one sample rate to a higher sample rate, providing listeners with higher levels of performance from any industry standard digital source, including PC and Media Servers. The resolution of each sample can be increased also. Up-sampling to progressively higher sample rates, if done carefully, yields progressive improvements to fine detail, sound stage depth and image separation. This means the sound quality increases as you up-sample CD data (16 bits at 44.1 kS/s) first to 24/88.2, then to 24/176.4, then to DSD®.

Using DDC 420 as an Upsampler to present data with a higher information capacity to the dCS™ Ring DAC, for example, results in extraordinary performance. In DDC 420, as in unit 110 of FIGS. 2 and 3, USB interface 434 operates in “asynchronous” mode, where the Upsampler synchronises the audio by providing a feedback pipe 438 to the PC. The PC then is effectively locked to the Upsampler, which can have a much more accurate clock and much lower jitter.

In a commercial embodiment of Digital-to-Digital Converter 420, digital inputs include: USB 2.0 interface on a B-type connector (operates in asynchronous isochronous mode); AES3 on a 3-pin female XLR connector; 4× SPDIF on 2× RCA Phono, 1× BNC connectors and 1× TosLink optical connector. All digital inputs will accept PCM data at up to 24 bit PCM at 32, 44.1, 48, 88.2 or 96 kS/s.

Data from any input may be converted by processor 440 and encoder 446 to 24 bit PCM at 32, 44.1, 48, 88.2, 96, 176.4 or 192 kS/s, or to DSD® (1 bit data at 2.822 MS/s). The output sample rate must be equal to or greater than the input sample rate.

The digital outputs include an IEEE 1394 interface 454 on 2× 6-way connectors, in DSD® mode, this interface outputs optionally-encrypted DSD® (1 bit data at 2.822 MS/s).

Two AES3 outputs 452 on 3-pin female XLR connectors, each output 24 bit PCM at 32, 44.1, 48, 88.2 or 96 kS/s, or act together as a Dual AES pair at 88.2, 96, 176.4 or 192 kS/s.

Two SPDIF outputs 450 are provided on RCA Phono and BNC connectors. Each outputs 24 bit PCM at 32, 44.1, 48, 88.2 or 96 kS/s. An SDIF-2 interface on 2× BNC connectors, outputs 24 bit PCM at 32, 44.1, 48, 88.2 or 96 kS/s.

Word clock input is provided on 1× BNC connector. This accepts standard word clock at 32, 44.1, 48, 88.2 or 96 kHz, sensitive to TTL levels.

A simple word clock output on 1× BNC connector outputs standard word clock frequency equal to the (single wire) output data rate, or 44.1 kHz when set to output DSD®.

Processor 440 in PCM mode can implement a choice of 4 filters which give different trade-offs between the Nyquist image rejection and the impulse response when converting 44.1 to 88.2, 44.1 to 176.4, 44.1 to DSD®, 48 to 96, 48 to 192 or 88.2 to DSD®.

The matching Master Clock unit 400 in the commercial embodiment is a grade 1 master clock, featuring eight word clock outputs. Like all of the applicant's products, this uses a sophisticated multi-mode phase locked loop (PLL), which significantly reduces clock jitter.

Higher capacity FPGAs (Field Programmable Gate Arrays) give more logic capacity and increase the scope for additional features and enhancements. Extensive use of programmable logic allows the product to adapt to changes in digital formats and add new features by loading new software from a CD. The same applies in the first example unit 110,

Unit 400 can generate 44.1 kHz or 48 kHz with an accuracy of better than ±1 ppm when shipped, typically ±0.1 ppm when shipped and stabilised. The Word clock outputs are 8 independently buffered outputs on 75 BNC connectors, all carrying the same clock frequency.

External Reference Input on 1× 75 BNC connector accepts word clock (with the Coupling menu page set to TTL) or AC coupled signals (with the Coupling menu page set to Bipolar) at 32 kHz, 44.1 kHz, 48 kHz, 88.2 kHz, 96 kHz, 1 MHz, 5 MHz & 10 MHz. Lock range is ±300 ppm.

Many variations and modifications beyond those mentioned in the description of the examples described above can be envisaged by the skilled reader. These variations and combinations of features from the different examples can be made without departing from the spirit and scope of the invention.

What is claimed is:

1. A computer audio interface unit comprising:
a serial computer interface providing a connector for connection to an external, computer-based source of digital audio data samples;
a digital audio output connector for providing a digital audio output signal to external audio reproduction apparatus;
a word clock output connector for provision of a word clock signal, in parallel with said digital audio output signal, to external audio reproduction apparatus;
an encoder for receiving digital audio data received via said serial computer interface and outputting said signals via said digital audio output connector; and
clocking circuitry responsive to a timing reference signal independent of said external source, for generating said word clock signal for output to the external audio reproduction apparatus and for generating a clock signal for the serial computer interface, so as to synchronise the drawing of said audio data samples via said serial computer interface with the generated external word clock signal and the digital audio output signal.

2. A unit according to claim 1 wherein the unit comprises a collection of components assembled within a stand-alone housing with its own power supply.

3. A unit according to claim 1 wherein the serial computer interface is a USB interface operable in asynchronous isochronous mode.

4. A unit according to claim 1 wherein the serial computer interface is implemented in an integrated circuit as a separate component.

5. A unit according to claim 4 wherein the clocking circuitry is arranged to generate two clock signals for application to the computer interface integrated circuit, namely an audio master clock signal at a frequency related to the sample rate of said digital audio data for clocking audio data out of the serial computer interface integrated circuit and a computer interface clock signal at a different frequency.

6. A unit according to claim 1 wherein the interface unit includes more than one word clock output for provision of word clock signals to more than one external unit.

7. A unit according to claim 1 wherein the interface unit is provided with a number of word clock output connectors greater than the number of digital audio output connectors.

8. A unit according to claim 1 wherein the interface unit includes an internal timing reference source for providing said timing reference signal.

9. A unit according to claim 1 wherein the timing reference has an operating accuracy better than 1 parts per million (ppm).

10. A unit according to claim 9 wherein the timing reference includes an oven-controlled crystal oscillator (OCXO), wherein the OCXO is based on a 14.112 MHz crystal, the frequency being multiplied and divided to give 44,100 Hz and/or 48,000 Hz word clocks as desired.

11. A unit according to claim 1 wherein the interface unit comprises an external word clock input for receiving said timing reference signal from an external timing reference source.

12. A unit according to claim 11 wherein the interface unit is provided in combination with a separate timing reference unit connectable to provide said timing reference signal.

13. A unit according to claim 11 wherein the external timing reference unit provides a plurality of word clock output connectors while the interface unit provides only one word clock output connector.

14. A unit according to claim 13 wherein the interface unit contains both an internal timing reference unit and an input for an external timing reference, and wherein the interface unit is provided in combination with an external timing reference unit having an accuracy greater than that of the internal timing reference unit.

15. A unit according to claim 1 in combination with an external disc transport unit, the disc transport unit having a word clock input and a digital audio output, and a disc reading mechanism operable synchronously with signals received from the interface unit via the word clock input.

16. A unit according to claim 1 in combination with a digital-to-analogue conversion unit (DAC) which has a word clock input and a digital audio data input suitable for receiving digital audio signal and word clock signals output by the interface unit.

17. A unit according to claim 1 wherein the clocking circuitry and encoder are operable to output digital audio at different sample rates selectable in accordance with a nominal sample rate of said external source.

18. A unit according to claim 17 wherein the interface unit includes a frequency selector for controlling the clocking circuitry automatically in response to control information received from the computer-based source through the serial computer interface to generate said word clock with a frequency compatible with data received from the computer-based source.

19. A unit according to claim 18 wherein the frequency selector is arranged automatically to revert to a user selected frequency in the absence of audio data from the serial computer interface.

20. A unit according to claim 1 wherein the clocking circuitry is operable to generate said word clock at a first rate for all sample rates based on 44.1 kHz and at a second rate all sample rates based on 48 kHz.

21. A unit according to claim 1 wherein the digital audio output interface is in SPDIF/AES format, via SPDIF and/or AES standard output connectors.

22. A unit according to claim 1 wherein the digital audio output interface is in a single-bit encoded format, such as DSD® format via an IEEE 1394 standard or other connector.

23. A unit as claimed in claim 1 wherein the encoder includes a rate conversion function operable to increase the sample rate of the output digital audio data relative to the rate of the data received from said external audio data source.

24. A unit as claimed in claim 23 wherein the rate conversion function is further operable to increase the number of bits per sample relative to the number of bits per sample of the data received from said external audio data source.
